(19) United States
(12) Patent Application Publication
(10) Pub. No.: US 2020/0385568 A1
(43) Pub. Date: Dec. 10, 2020

(54) Polylactide Based Compositions

(71) Applicant: TOTAL RESEARCH & TECHNOLOGY FELUY, Seneffe (BE)

(72) Inventor: Thierry COUPIN, Carnieres (BE)

(73) Assignee: Total Research & Technology Feluy, Seneffe (BE)

(21) Appl. No.: 16/641,325

(22) PCT Filed: Aug. 9, 2018
(86) PCT No.: PCT/EP2018/071665

§ 371 Date: Feb. 24, 2020

(30) Foreign Application Priority Data
Aug. 24, 2017 (EP) 17187797.0

(51) Int. Cl. C08L 67/04

(52) U.S. Cl. CPC C08L 67/04

(57) ABSTRACT

The present invention relates to composition comprising at least two polymers, wherein,
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block; or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block.

The present invention relates to a process for preparing said composition, articles comprising said composition, the use of block copolymers as nucleating agent and stereo-complex forming agent.

### FIELD OF THE INVENTION

The invention pertains to a composition comprising a polylactide-based polymer, and the use thereof.

### BACKGROUND OF THE INVENTION

Polylactide also referred as polylactic acid (PLA) is a synthetic aliphatic polyester derived from renewal resources, such a corn, sugar beet and cassava, which can ultimately be degraded under composting conditions.

Although attempts have been made to utilize PLA for various end-use applications, PLA is known to be brittle and exhibit low toughness, which can result in low impact strength products or articles. Impact resistance of PLA can be modified by using existing polymeric impact modifiers; however, currently available polymeric impact modifiers always decrease transparency of PLA material. A liquid plasticizer can be used at high content (>15%) to improve impact resistance of PLA, however during the life time of the PLA blend, there is migration of the plasticizer.

Impact modifiers such as rubber, poly(ethylene glycol) (PEG), and acrylonitrile-butadiene-styrene copolymer (ABS) have been tested. Nevertheless, the immiscibility between these impact modifying additives and the PLA matrix is a major drawback.

Commercially available BioStrength® 150 a methyl methacrylate-butadiene-styrene copolymer (MBS) is one of the best currently available impact modifiers for PLA; however haze of the resulting PLA material increases from 5, for pure PLA to 95 when 15% w/w of BioStrength® 150 is added. Another commercial product, BioStrength® 280, an acrylic core shell impact modifier, is a less efficient impact modifier, although the resulting PLA material is said to remain transparent. Nevertheless, the present inventors observed that addition of 15% w/w of BioStrength® 280 produces a material with a haze of 44.

Plasticizers are additives that increase the fluidity of a material. Commonly used plasticizers, are tributyl citrate (TBC) and acetyl tributyl citrate (ATBC). However, when 15% TBC or ATBC were mixed with PLA, the present inventors observed a plasticizer migration after storage for a few days at room temperature in summer time (25-30° C.).

Other commonly used polymer modifiers are styrene block copolymers, such as poly(styrene-butadiene-styrene), or SBS. Further studies performed by the present inventors, showed that a blend of PLA with SBS exhibited a total incompatibility even at a concentration as low as 10% w/w of SBS.

Another problem with PLA is that the melting temperature and the thermal stability is rather low, making PLA unsuitable for certain application where even only a small amount of heat is involved.

There is therefore a need to improve the compositions of the prior art.

### SUMMARY OF THE INVENTION

The inventors have surprisingly found that polylactide-polyfarnesene (PLA-PF) block copolymer, influence significantly crystallinity of PLA. Further has been found that polylactide-polyfarnesene (PLA-PF) block copolymer mixed with PLA influences and/or improve impact properties of PLA based composition in comparison to polylactide based composition alone, or in comparison with standard impact modifiers.

The inventors have surprisingly found that the melting temperature of a composition comprising said polylactide-polyfarnesene (PLA-PF) block copolymer and polylactide is higher than the melting temperature of polylactide alone. It has been found that a stereocomplex can be formed in polylactide with said polylactide-polyfarnesene (PLA-PF) block copolymer. These compositions can have improved transparency, while keeping other properties such as processing, compared to pure PLA.

A first aspect of the present invention provides a composition comprising at least two polymers, wherein,
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block,
wherein said block copolymer is the reaction product of:
   at least one functionalized polyfarnesene comprising a polymeric chain derived from farnesene and having at least one functional terminal end selected from the group comprising hydroxyl, amino, epoxy, isocyanato, and carboxylic acid; and,
   at least one lactide.

The present inventors have surprisingly found that said first polymer has an influence on the crystallization of said second polymer. It was found that the first polymer works as a nucleating agent and that said first polymer can be used to form a stereo complex with said second polymer.

A second aspect of the present invention encompasses a process for preparing a composition according to the first aspect of the invention comprising the step of contacting at least one first polymer with at least one second polymer; wherein
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block,
wherein said block copolymer is the reaction product of:
   at least one functionalized polyfarnesene comprising a polymeric chain derived from farnesene and having at least one functional terminal end selected from the group comprising hydroxyl, amino, epoxy, isocyanato, and carboxylic acid; and,
   at least one lactide.

A third aspect of the invention encompasses an article comprising a composition according to the first aspect of the invention, or formed using a process according the second aspect of the invention.

A fourth aspect of the invention encompasses the use of a block copolymer comprising at least one polyfarnesene block and at least one polylactide block, wherein said polylactide block is a poly-L-lactide block or a poly-D-lactide block, as nucleating agent for polymers.

A fifth aspect of the invention encompasses the use of a block copolymer comprising at least one polyfarnesene block and at least one polylactide block, wherein said polylactide block is a poly-L-lactide block or a poly-D-lactide block, as stereo-complex forming agent for polylactide.

A sixth aspect of the invention encompasses the use of a block copolymer comprising at least one polyfarnesene block and at least one polylactide block, wherein said polylactide block is a poly-L-lactide block or a poly-D-lactide block, as melting point increasing agent for polylactide.

A seventh aspect of the invention encompasses the use of a block copolymer comprising at least one polyfarnesene block and at least one polylactide block, wherein said polylactide block is a poly-L-lactide block or a poly-D-lactide block, as time regulator for biodegradability of polylactide.

The above and other characteristics, features and advantages of the present invention will become apparent from the following detailed description, taken in conjunction with the accompanying drawings, which illustrate, by way of example, the principles of the invention. The reference figures quoted below refer to the attached drawings.

### BRIEF DESCRIPTION OF THE FIGURES

FIG. 1 represents a graph showing the DSC profile of a composition according to an embodiment of the invention.

FIG. 2 represents a graph showing the DSC profile of a composition according to an embodiment of the invention.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

Preferred statements (features) and embodiments of the compositions, polymers, processes, articles, and uses of this invention are set herein below. Each statement and embodiment of the invention so defined may be combined with any other statement and/or embodiment, unless clearly indicated to the contrary. In particular, any feature indicated as being preferred or advantageous may be combined with any other features or statements indicated as being preferred or advantageous. Hereto, the present invention is in particular captured by any one or any combination of one or more of the below numbered aspects and embodiments 1 to 44, with any other statement and/or embodiment.
1. A composition comprising at least two polymers, wherein,
   (a) the first polymer is a block copolymer comprising at least one polyfarnesene block and at least one poly-L-lactide block; and,
   (b) the second polymer is selected from poly-D-lactide, or a block copolymer comprising at least one polyfarnesene block and at least one poly-D-lactide block;
      or,
   (a) the first polymer is a block copolymer comprising at least one polyfarnesene block and at least one poly-D-lactide block; and,
   (b) the second polymer is selected from poly-L-lactide, or a block copolymer comprising at least one polyfarnesene block and at least one poly-L-lactide block,
      wherein said block copolymer is the reaction product of:
   at least one functionalized polyfarnesene comprising a polymeric chain derived from farnesene and having at least one functional terminal end selected from the group comprising hydroxyl, amino, epoxy, isocyanato, and carboxylic acid; and,
   at least one lactide.
2. The composition according to statement 1, wherein said block copolymer is the reaction product of:
   at least one polymeric chain derived from farnesene and having at least one functional terminal end selected from the group comprising hydroxyl, amino, epoxy, isocyanato, and carboxylic acid; and,
   at least one lactide.
3. The composition according to any one of statements 1-2, wherein said block copolymer comprising at least one polyfarnesene block and at least one poly-L-lactide block is selected from the group comprising PLLA-PF diblock copolymer, PLLA-PF-PLLA triblock copolymer, PLLA-PF multiblock copolymer, PLLA-PF star copolymers, PLLA-PF gradient containing block copolymers; and mixtures thereof; preferably said block copolymer is a PLLA-PF diblock copolymer or a PLLA-PF-PLLA triblock copolymer.
4. The composition according to any one of statements 1-3, wherein said block copolymer comprising at least one polyfarnesene block and at least one poly-L-lactide block is a PLLA-PF diblock copolymer or PLLA-PF-PLLA triblock copolymer.
5. The composition according to any one of statements 1-2, wherein said block copolymer comprising at least one polyfarnesene block and at least one poly-D-lactide block is selected from the group comprising PDLA-PF diblock copolymer, PDLA-PF-PLA triblock copolymer, PDLA-PF multiblock copolymer, PDLA-PF star copolymers, PDLA-PF gradient containing block copolymers; and mixtures thereof; preferably said block copolymer is a PDLA-PF diblock copolymer or a PDLA-PF-PDLA triblock copolymer.
6. The composition according to any one of statements 1-2, 5, wherein said block copolymer comprising at least one polyfarnesene block and at least one poly-D-lactide block is a PDLA-PF diblock copolymer or PDLA-PF-PDLA triblock copolymer.
7. The composition according to any one of statements 1-6, wherein the number average molecular weight Mn of the at least one polyfarnesene block of said first polymer and/or said second polymer is at least 1.5 kDa, preferably at least 2.0 kDa, preferably at least 3.0 kDa, for example at least 4.0 kDa, for example at least 5.0 kDa, for example at least 6.0 kDa, for example at least 7.0 kDa, for example at least 8.0 kDa, for example at least 9.0 kDa, for example at least 10 kDa, for example at least 12 kDa, for example at least 15 kDa, for example at least 17 kDa, for example at least 18 kDa, for example at least 20 kDa, for example at least 30 kDa, for example at least 40 kDa, for example at least 50 kDa, for example at least 60 kDa, for example at least 70 kDa, for example at least 80 kDa, for example at least 90 kDa, for example at least 100 kDa, for example at least 110 kDa, for example at least 120 kDa, for example at least 130 kDa, for example at least 150 kDa, for example at least 200 kDa.
8. The composition according to any one of statements 1-7, wherein the number average molecular weight Mn of the at least one polyfarnesene block of said first polymer and/or said second polymer is at most 300 kDa, at most 250 kDa, preferably at most 240 kDa, preferably at most 230 kDa, preferably at most 220 kDa, for example at most 210 kDa, for example at most 200 kDa, for example at most 150 kDa, for example at most 140 kDa.
9. The composition according to any one of statements 1-8, wherein the number average molecular weight Mn of the at least one polyfarnesene block of said first polymer and/or said second polymer is preferably from 1.5 to 300 kDa, preferably from 2 to 250 kDa, preferably from 5 to 240 kDa, more preferably from 10 to 210 kDa, preferably from 15 to 200 kDa, preferably from 20 to 150 kDa.
10. The composition according to any one of statements 1-9, wherein the number average molecular weight Mn of the at least one polylactide block of said first polymer and/or said second polymer is at least 0.1 kDa, preferably at least 0.2 kDa, preferably at least 0.5 kDa, for example at least 0.7 kDa, for example at least 0.8 kDa, for example at least 0.9 kDa, for example at least 1.0 kDa, for example at least 2.0 kDa, for example at least 3.0 kDa, for example at least 5.0 kDa, for example at least 10 kDa, for example at least 15 kDa, for example at least 20 kDa, for example at least 30 kDa, for example at least 40 kDa, for example at least 50 kDa, for example at least 60 kDa, for example at least 70 kDa, for example at least 80 kDa, for example at least 90 kDa, for example at least 100 kDa, for example at least 150 kDa.
11. The composition according to any one of statements 1-10, wherein the number average molecular weight Mn of the at least one polylactide block of said first polymer and/or said second polymer is at most 400 kDa, preferably at most 350 kDa, preferably at most 300 kDa, for example at most 250 kDa, for example at most 200 kDa, for example at most 190 kDa, for example at most 180 kDa, for example at most 170 kDa, for example at most 160 kDa, for example at most 150 kDa, for example at most 140 kDa, for example at most 130 kDa, for example at most 120 kDa, for example at most 110 kDa, for example at most 111 kDa.
12. The composition according to any one of statements 1-11, wherein the number average molecular weight Mn of the at least one polylactide block of said first polymer and/or said second polymer is preferably from 0.2 to 400 kDa, preferably from 1 to 250 kDa, preferably from 2 to 250 kDa, preferably from 3 to 250 kDa, preferably from 10 to 200 kDa, more preferably from 20 to 170 kDa, preferably from 30 to 140 kDa, preferably from 60 to 111 kDa.
13. The composition according to any one of statements 1-12, wherein the first polymer is a block copolymer comprising at least one polyfarnesene block and at least one poly-L-lactide block, and the second polymer is a block copolymer comprising at least one polyfarnesene block and at least one poly-D-lactide block.
14. The composition according to any one of statements 1-12, wherein the first polymer is a block copolymer comprising at least one polyfarnesene block and at least one poly-D-lactide block, and the second polymer is a block copolymer comprising at least one polyfarnesene block and at least one poly-L-lactide block.
15. The composition according to any one of statements 1-12 wherein the first polymer is a block copolymer comprising at least one polyfarnesene block and at least one poly-L-lactide block, and the second polymer is poly-D-lactide.
16. The composition according to any one of statements 1-12 wherein the first polymer is a block copolymer comprising at least one polyfarnesene block and at least one poly-D-lactide block, and the second polymer is a poly-L-lactide.
17. The composition according to any one of statements 1-16, wherein said composition comprises said first polymer in an amount of at least 1.0% by weight, preferably at least 5.0% by weight, preferably at least 10% by weight, for example at least 15% by weight, for example at least 20% by weight, for example at least 25% by weight, for example at least 26% by weight, for example at least 27% by weight, for example at least 28% by weight, for example at least 30% by weight, based on the total weight of the composition.
18. The composition according to any one of statements 1-17 wherein said composition comprises said first polymer in an amount of at most 70% by weight, preferably at most 65% by weight, preferably at most 60% by weight, for example at most 55% by weight, for example at most 50% by weight based on the total weight of the composition.
19. The composition according to any one of statements 1-18, wherein said composition comprises from 1% to 70% by weight, preferably from 5 to 60% by weight, preferably from 10 to 50% by weight, preferably from 15 to 40% by weight, preferably from 20 to 30% by weight of said first polymer based on the total weight of the composition.
20. The composition according to any one of statements 1-19, wherein for the block copolymer, the number average molecular weight is the same within 1000 Da for two or more polylactide blocks.
21. The composition according to any one of statements 1-20, wherein the functionalized polyfarnesene comprises a polymeric chain derived from farnesene and having at least one functional terminal end selected from the group comprising hydroxyl, amino, and epoxy.
22. The composition according to any one of statements 1-21, wherein the functionalized polyfarnesene comprises a polymeric chain derived from farnesene and having at least one functional terminal end selected from the group comprising hydroxyl and amino.
23. The composition according to any one of statements 1-22, wherein the functionalized polyfarnesene comprises a polymeric chain derived from farnesene and having at least one hydroxyl terminal end.
24. The composition according to any one of statements 1-23, wherein said composition comprises from 30% to 99% by weight, preferably from 40 to 95% by weight, preferably from 50 to 90% by weight, preferably from 60 to 85% by weight, preferably from 70 to 80% by weight of said second polymer based on the total weight of the composition.
25. The composition according to any one of statements 1-24, comprising
   from 1% to 70% by weight of poly-D-lactide-polyfarnesene block copolymer based on the total weight of the composition; and from 30% to 99% by weight of the second polymer (b) based on the total weight of the composition;
   and/or,
   from 1% to 70% by weight of poly-L-lactide-polyfarnesene block copolymer based on the total weight of the composition; and from 30% to 99% by weight of the second polymer (b) based on the total weight of the composition.
26. The composition according to any one of statements 1-25, wherein for the block copolymer, wherein the ratio of the number average molecular weight of the at least one polyfarnesene block over the number average molecular weight of the at least one polylactide block is from 1/0.1 to 1/4.0, preferably from 1/0.4 to 1/3.5, preferably from 1/0.7 to 1/2.3, preferably from 1/0.9 to 1/2.0, preferably from 1/1.0 to 1/1.5.
27. The composition according to any one of statements 1-26, wherein the number average molecular weight Mn of said block copolymer is at least 2 kDa, preferably at least 5 kDa, preferably at least 10 kDa, preferably at least 15 kDa, for example at least 20 kDa, for example at least 25 kDa, for example at least 30 kDa, for example at least 35 kDa, for example at least 40 kDa, for example at least 45 kDa, for example at least 50 kDa, for example at least 55 kDa.
28. The composition according to any one of statements 1-27, wherein the number average molecular weight Mn of said block copolymer is at most 500 kDa, preferably at most 400 kDa, preferably at most 350 kDa, preferably at most 300 kDa, for example at most 250 kDa, for example at most 200 kDa, for example at most 150 kDa, for example at most 140 kDa, for example at most 130 kDa, for example at most 120 kDa, for example at most 110 kDa.
29. The composition according to any one of statements 1-28, wherein the number average molecular weight Mn of said block copolymer is from 2 kDa to 500 kDa, preferably from 10 kDa to 400 kDa, preferably from 25 kDa to 250 kDa, preferably from 40 kDa to 160 kDa, preferably 55 kDa to 110 kDa.
30. The composition according to any one of statements 1-29, wherein the molecular weight distribution D (Mw/Mn) of the block copolymer is from 1.0 to 2.5, preferably from 1.2 to 2.1, preferably from 1.4 to 1.9, preferably from 1.7 to 1.8.
31. A process for preparing a composition according to any one of statements 1-30 comprising the step of:
   contacting at least one first polymer with at least one second polymer; wherein
      (a) the first polymer is a block copolymer comprising at least one polyfarnesene block and at least one poly-L-lactide block; and,
      (b) the second polymer is selected from poly-D-lactide, or a block copolymer comprising at least one polyfarnesene block and at least one poly-D-lactide block;
   or,
      (a) the first polymer is a block copolymer comprising at least one polyfarnesene block and at least one poly-D-lactide block; and,
      (b) the second polymer is selected from poly-L-lactide, or a block copolymer comprising at least one polyfarnesene block and at least one poly-L-lactide block,
   wherein said block copolymer is the reaction product of:
   at least one functionalized polyfarnesene comprising a polymeric chain derived from farnesene and having at least one functional terminal end selected from the group comprising hydroxyl, amino, epoxy, isocyanato, and carboxylic acid; and,
   at least one lactide.
32. The process according to statement 31, wherein said contacting step comprises melt blending the at least one first polymer with the at least one second polymer.
33. The process according to any one of statements 31-32, wherein said composition is melt blended at a temperature ranging from 160° C. to 230° C., preferably at a temperature ranging from 160° C. to 200° C.
34. The process according to any one of statements 31-33, comprising melt processing a blend a block copolymer comprising at least one polyfarnesene block and at least one poly-L-lactide block and a block copolymer comprising at least one polyfarnesene block and at least one poly-D-lactide block to allow formation of PLLA/PDLA stereocomplex crystallites in the blend during the processing.
35. The process according to any one of statements 31-34, further comprising processing the composition using one or more polymer processing techniques selected from film, sheet, pipe and fiber extrusion or coextrusion; blow molding; injection molding; rotomolding; foaming; and thermoforming.
36. An article comprising a composition according to any one of statements 1-30, or formed using a process according to any one of statements 31-35.
37. Use of a block copolymer comprising at least one polyfarnesene block and at least one polylactide block, wherein said polylactide block is a poly-L-lactide block or a poly-D-lactide block, as nucleating agent for polymers.
38. Use according to statement 37, wherein said block copolymer is poly-L-lactide-polyfarnesene block copolymer or poly-D-lactide-polyfarnesene block copolymer.
39. Use according to any one of statements 37-38, wherein said polymer is polylactide, preferably optical pure polylactide.
40. Use of a block copolymer comprising at least one polyfarnesene block and at least one polylactide block, wherein said polylactide block is a poly-L-lactide block or a poly-D-lactide block, as stereo-complex forming agent for polylactide.
41. Use according to statement 40, wherein said block copolymer is poly-L-lactide-polyfarnesene block copolymer or poly-D-lactide-polyfarnesene block copolymer.
42. Use of a block copolymer comprising at least one polyfarnesene block and at least one polylactide block, wherein said polylactide block is a poly-L-lactide block or a poly-D-lactide block, as melting point increasing agent for polylactide.
43. Use according to statement 42, wherein said block copolymer is poly-L-lactide-polyfarnesene block copolymer or poly-D-lactide-polyfarnesene block copolymer.
44. Use of a block copolymer comprising at least one polyfarnesene block and at least one polylactide block, wherein said polylactide block is a poly-L-lactide block or a poly-D-lactide block, as time regulator for biodegradability of polylactide.

According to the first aspect of the invention, a composition comprising at least two polymers, wherein,
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block.

Preferably said block copolymer is the reaction product of:
at least one functionalized polyfarnesene comprising a polymeric chain derived from farnesene and having at least one functional terminal end selected from the group comprising hydroxyl, amino, epoxy, isocyanato, and carboxylic acid; and,
at least one lactide.

Suitable block copolymer of said at least one first polymer and/or said at least one second polymer comprises polymer comprising multiple sequences, or blocks, of the same monomer alternating in series with different monomer blocks; these blocks are covalently bound to each other. Block copolymers are normally prepared by controlled polymerization of one monomer, followed by chain extension with a different monomer. Block copolymers are classified based on the number of blocks they contain and how the blocks are arranged. For example, block copolymers with two blocks are called diblocks; those with three blocks are triblocks; and those with more than three are generically called multiblocks. Classifications by arrangement include the linear, or end-to-end, arrangement and the star arrangement, in which one polymer is the base for multiple branches.

In an embodiment, said at least one first polymer and/or said at least one second polymer is selected from diblock copolymer, triblock copolymer, multiblock copolymer, star copolymers, comb copolymers, gradient containing block copolymers, and other copolymers having a blocky structure, which will be known by those skilled in the art. Preferred are diblock and triblock copolymers. An example of a gradient containing block copolymer is when the monomer or monomers used from one segment are allowed to further react as a minor component in the next sequential segment. For example, if the monomer mix used for the 1st block (A block) of an AB diblock copolymer is polymerized to only 80% conversion, then the remaining 20% of the unreacted monomer is allowed to react with the new monomers added for the B block segment, the result is an AB diblock copolymer in which the B segment contains a gradient of the A segment composition. The term “comb copolymer,” as used herein, describes a type of graft copolymer, wherein the polymeric backbone of the graft copolymer is linear, or essentially linear and is made of one polymer A, and each side chain (graft segment) of the graft copolymer is formed by a polymer B that is grafted to the polymer A backbone.

Used herein, the terms “comb copolymer” and “graft copolymer” have the same meaning.

Preferably, said at least one first polymer and/or said at least one second polymer is selected from the group comprising PLA-PF diblock copolymer, PLA-PF-PLA triblock copolymer, PLA-PF multiblock copolymer, PLA-PF star copolymers, PLA-PF gradient containing block copolymers; and mixtures thereof; preferably said block copolymer is a PLA-PF diblock copolymer or a PLA-PF-PLA triblock copolymer.

Preferably, said at least one first polymer and/or said at least one second polymer is a di-block or a triblock copolymer.

In an embodiment, said poly-L-lactide-polyfarnesene (PLLA-PF) block copolymer is selected from the group comprising PLLA-PF diblock copolymer, PLLA-PF-PLLA triblock copolymer,

PLLA-PF multiblock copolymer, PLLA-PF star copolymers, PLLA-PF comb copolymers, and PLLA-PF gradient containing block copolymers. Preferable diblock and triblock copolymers include PLLA-PF and PLLA-PF-PLLA block copolymers.

In an embodiment, said poly-D-lactide-polyfarnesene (PDLA-PF) block copolymer is selected from the group comprising PDLA-PF diblock copolymer, PDLA-PF-PDLA triblock copolymer,

PDLA-PF multiblock copolymer, PDLA-PF star copolymers, PDLA-PF comb copolymers, and PDLA-PF gradient containing block copolymers. Preferable diblock and triblock copolymers include PDLA-PF and PDLA-PF-PDLA block copolymers.

In some embodiments, the block copolymer of said at least one first polymer and/or said at least one second polymer may comprise one polyfarnesene block.

In some embodiments, the block copolymer of said at least one first polymer and/or said at least one second polymer may comprise one or two polylactide blocks and in some embodiments the block copolymer comprises just two polylactide blocks.

In some embodiments, the at least one first polymer is poly-L-lactide-polyfarnesene block copolymer and the at least one second polymer is selected from poly-D-lactide, poly-D-lactide-polyfarnesene block copolymer, or mixture thereof.

In some embodiments, the at least one first polymer is poly-D-lactide-polyfarnesene block copolymer and the at least one second polymer is selected from poly-L-lactide, poly-L-lactide-polyfarnesene block copolymer, or mixture thereof.

In some embodiments, the at least one first polymer is poly-L-lactide-polyfarnesene block copolymer and the at least one second polymer is poly-D-lactide-polyfarnesene block copolymer.

In some embodiments, the at least one first polymer is poly-D-lactide-polyfarnesene block copolymer and the at least one second polymer is poly-L-lactide-polyfarnesene block copolymer.

In some embodiments, the at least one first polymer is poly-L-lactide-polyfarnesene block copolymer and the at least one second polymer is poly-D-lactide.

In some embodiments, the at least one first polymer is poly-D-lactide-polyfarnesene block copolymer and the at least one second polymer is poly-L-lactide.

In some embodiments, said composition comprises from 1% to 70% by weight, preferably from 5 to 60% by weight, preferably from 10 to 50% by weight, preferably from 15 to 40% by weight, preferably from 20 to 30% by weight of said at least one first polymer based on the total weight of the composition.

In some embodiments, said composition comprises:

from 1% to 70% by weight of poly-D-lactide-polyfarnesene block copolymer based on the total weight of the composition; and from 30% to 99% by weight of the second polymer (b) based on the total weight of the composition;

and/or, from 1% to 70% by weight of poly-L-lactide-polyfarnesene block copolymer based on the total weight of the composition; and from 30% to 99% by weight of the second polymer (b) based on the total weight of the composition.

In some embodiments, the melt temperature of the block copolymer of said at least one first polymer and/or said at least one second polymer is from 130 to 180° C., preferably from 150 to 177° C., preferably from 170 to 175° C., determined according to ISO 11357 with a gradient from 20 to 260° C. at 20° C./min.

In some embodiments, the crystallization temperature of the block copolymer of said at least one first polymer and/or said at least one second polymer is from 95° C. to 130° C., preferably from 100 to 126° C., preferably from 107 to 117° C., determined according to ISO 11357 with a gradient from 20 to 260° C. at 20° C./min.

In some embodiments, the block copolymer of said at least one first polymer and/or said at least one second polymer has a tensile modulus from 5.0 to 2700.0 MPa, preferably from 350.0 to 2500.0 MPa, preferably from 900.0 to 2300.0 MPa, preferably from 1500.0 to 2200.0 MPa, determined according to ISO527-2012_1 BA.

In some embodiments, the block copolymer of said at least one first polymer and/or said at least one second polymer has a tensile strength at yield from 0.5 to 75.0 MPa, preferably from 0.7 to 60.0 MPa, preferably from 1.0 to 40.0 MPa, preferably from 5.0 to 20.0 MPa determined according to ISO527-2012_1BA.

In some embodiments, the block copolymer of said at least one first polymer and/or said at least one second polymer has an elongation at yield from 0.5 to 10.0%, preferably from 0.7 to 7.0%, preferably from 1.0 to 5.0% MPa, preferably from 1.0 to 3.0% determined according to ISO527-2012_1 BA.

In some embodiments, the block copolymer of said at least one first polymer and/or said at least one second polymer has a tensile strength at break from 0.1 to 60.0 MPa, preferably from 0.6 to 40.0 MPa, preferably from 0.8 to 30.0 MPa, preferably from 1.0 to 18.0 MPa determined according to ISO527-2012_1 BA.

In some embodiments, the block copolymer of said at least one first polymer and/or said at least one second polymer has an elongation at break from 0.5 to 70.0%, preferably from 0.7 to 50.0%, preferably from 1.0 to 25.0% MPa, preferably from 1.0 to 13.0% determined according to ISO527-2012_1 BA.

According to the invention, said block copolymer is the reaction product of:
at least one functionalized polyfarnesene comprising a polymeric chain derived from farnesene wherein said polymeric chain has (comprises) at least one functional terminal end selected from the group comprising hydroxyl, amino, epoxy, isocyanato and carboxylic acid; and,
at least one lactide;
   thereby forming at least one polyfarnesene block and at least one polylactide block.

According to the invention, the at least one functionalized polyfarnesene comprises a polymeric chain derived from farnesene, wherein said polymeric chain has (comprises) at least one functional terminal end selected from the group comprising hydroxyl, amino, epoxy, isocyanato and carboxylic acid, preferably said polymeric chain derived from farnesene comprises at least one functional terminal end selected from the group comprising hydroxyl, amino, and epoxy, more preferably said polymeric chain derived from farnesene comprises at least one functional terminal end selected from the group comprising hydroxyl, and amino, most preferably said polymeric chain derived from farnesene comprises at least one hydroxyl terminal end, for example one or two hydroxyl terminal ends. In a preferred embodiment, the at least one functionalized polyfarnesene comprises a polymeric chain derived from farnesene comprising one or two functional terminal ends selected from the group comprising hydroxyl, amino, epoxy, isocyanato and carboxylic acid, preferably said polymeric chain derived from farnesene comprises one or two functional terminal ends selected from the group comprising hydroxyl, amino, and epoxy, more preferably said polymeric chain derived from farnesene comprises a one or two functional terminal ends selected from the group comprising hydroxyl, and amino, most preferably said polymeric chain derived from farnesene comprises one or two hydroxyl terminal ends. As used herein the term “functionalized polyfarnesene comprising a polymeric chain derived from farnesene and having at least one hydroxyl terminal end” is also referred as “hydroxyl functionalized polyfarnesene”.

The polymeric chain derived from farnesene may be obtained by polymerizing a monomer feed that primarily includes farnesene.

Farnesene exists in isomer forms, such as α-farnesene ((E,E)-3,7,11-trimethyl-1,3,6,10-dodecatetraene) and β-farnesene (7,11-dimethyl-3-methylene-1,6,10-dodecatriene). As used in the specification and in the claims, “farnesene” means (E)-β-farnesene also referred as trans-β-farnesene, (CAS 18794-84-8) having the following structure:

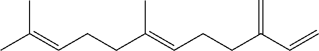

as well (E)-β-farnesene in which one or more hydrogen atoms have been replaced by another atom or group of atoms (i.e. substituted).

The farnesene monomer used to produce various embodiments of the block copolymer according to the present invention, is commercially available and may be prepared by chemical synthesis from petroleum resources, extracted from insects, such as Aphididae, or plants. Therefore, an advantage of the present invention is that the block copolymer may be derived from a monomer obtained via a renewable resource. The monomer may be prepared by culturing a microorganism using a carbon source derived from a saccharide. The polymeric chain derived from farnesene may be efficiently prepared from farnesene monomer obtained via these sources. The saccharide used may be any of monosaccharides, disaccharides, and polysaccharides, or may be a combination thereof. Examples of monosaccharides include glucose, galactose, mannose, fructose, and ribose. Examples of disaccharides include sucrose, lactose, maltose, trehalose, and cellobiose. Examples of polysaccharides include starch, glycogen, and cellulose.

The cultured microorganism that consumes the carbon source may be any microorganism capable of producing farnesene through culturing. Examples thereof include eukaryotes, bacteria, and archaebacteria. Examples of eukaryotes include yeast and plants. The microorganism may be a transformant obtained by introducing a foreign gene into a host microorganism. The foreign gene is not particularly limited, and it is preferably a foreign gene involved in the production of farnesene because it can improve the efficiency of producing farnesene.

In the case of recovering farnesene from the cultured microorganism, the microorganism may be collected by centrifugation and disrupted, and then farnesene can be extracted from the disrupted solution with a solvent. Such solvent extraction may appropriately be combined with any known purification process such as distillation.

Any methods known by those having skill in the art may be used to provide the polyfarnesene described herein. Anionic polymerization may be desirable because anionic polymerization allows greater control over the final molecular weight of the polymeric chain, i.e. narrow molecular weight distributions and predictable molecular weights. The functional terminal end of the polymeric chain may also be easily quenched, for example, by using an alkylene oxide followed by contact with a protic source providing a monol or diol.

The polymeric chain derived from farnesene described herein may be prepared by a continuous solution polymerization process wherein an initiator, monomers, and a suitable solvent are continuously added to a reactor vessel to form the desired polymeric chain. Alternatively, the polymeric chain may be prepared by a batch process in which all of the initiator, monomers, and solvent are combined in the reactor together substantially simultaneously. Alternatively, the polymeric chain may be prepared by a semi-batch process in which all of the initiator and solvent are combined in the reactor together before a monomer feed is continuously metered into the reactor.

Initiators for providing a polymeric chain with a living terminal chain end(s) include, but are not limited to, organic salts of alkali metals. Non-limiting suitable examples of such initiators are lithium and di-lithium based initiator as described in DD-231361 A1 and in WO 2016/209953 A1, hereby incorporated by reference. The polymerization reaction temperature of the mixture in the reactor vessel may be maintained at a temperature of about −80 to 80° C.

In some embodiments, when a mono-functionalized polyfarnesene is intended to be produced, a monovalent initiator is used. In some embodiments, when a di-functionalized polyfarnesene is intended to be produced, a divalent initiator is used.

As understood by those having skill in the art, living anionic polymerization may continue, as long as monomer is fed to the reaction. In some embodiments, the polymeric chain derived from farnesene may be obtained by polymerization of farnesene and optionally one or more comonomers. Examples of comonomers include, but are not limited to, dienes, such as butadiene, isoprene, and myrcene, or vinyl aromatics, such as styrene and alpha methyl styrene. In one embodiment of the disclosed methods and compositions, a method of manufacturing the polymeric chain may comprise polymerizing a monomer feed, wherein the monomer feed comprises farnesene monomer and optionally at least one comonomer in which the comonomer content of the monomer feed is 75% by weight, preferably 50% by weight, and preferably 25% by weight, based on the total weight of the monomer feed. The polymerization conditions and monomer feed may be controlled as may be desired so as to provide, for example, polymeric chain having a random, block or gradient structure.

Upon reaching a desired molecular weight, the polymeric chain may be obtained by quenching the living terminal end with a compound having the selected functionality or by providing the terminal end with a reactive group that may be subsequently functionalized. As noted previously, the functionalized polyfarnesene is provided as a polymeric chain having at least one functional terminal end selected from the group comprising hydroxyl, amino, epoxy, isocyanato and carboxylic acid.

In some embodiments, for the functionalized polyfarnesene provided in the form of a polymeric chain having one or two hydroxyl end groups, anionic polymerization may be concluded by a quenching step in which one or two living terminal ends of the polymeric chain are reacted with an alkylene oxide, such as propylene oxide, and a protic source, such as an acid, resulting in a monol, i.e. a hydroxyl group on one of the terminal ends of the polymeric chain or a diol, i.e. a hydroxyl group at both the terminal ends of the polymeric chain.

In another example, the functionalized polyfarnesene may be provided in the form of a polymeric chain having one or two carboxylic acid end group. In one method, following anionic polymerization of farnesene monomers to provide a polyfarnesene chain having one or two living terminal ends, the living terminal ends may be contacted with carbon dioxide gas to provide a terminal end with a carboxylate followed by quenching the carboxylate with an acid, such as hydrochloric, phosphoric, or sulfuric acid to convert the carboxylate into a carboxylic acid. In another method, the carboxylic acid-terminated polyfarnesene may be obtained by reacting a polyfarnesene-based monol or diol with a cyclic anhydride. Examples of cyclic anhydrides include, but are not limited to, phthalic anhydride, succinic anhydride, maleic anhydride, trimellitic anhydride, hexahydrophthalic anhydride, methyltetrahydrophthalic anhydride, itaconic anhydride, pyromellitic dianhydride, benzophenonetetracarboxylic dianhydride, and cyclopentanetetracarboxylic dianhydride.

In yet another example, the functionalized polyfarnesene may be provided in the form of a polymeric chain having one or two amino end groups. In one method, a polyfarnesene based monol or diol may be reacted with an alkane- or arenesulfonyl chloride or fluoride in the presence of a tertiary amine catalyst to form an alkane- or arenesulfonate terminated precursor. The alkane- or arenesulfonate terminated polymer may then be reacted with a primary amine or ammonia to provide the amine-terminated polyfarnesene.

Typical alkane- or arenesulfonyl compounds include, but are not limited to, methanesulfonyl chloride, methanesulfonyl fluoride, ethanesulfonyl chloride, ethanesulfonyl fluoride, p-toluenesulfonyl chloride, and p-toluenesulfonyl fluoride. Primary amines that may be reacted with the alkane- or arenesulfonate terminated polymer include, for example, ethylamine, propylamines, allylamine, n-amylamine, butylamines, cyclohexylamine, n-tetradecylamine, benzylamine, aniline, toluidines, naphthylamine and the like.

In an alternative method for producing an amine-terminated polyfarnesene, a polyfarnesene-based monol or diol may be directly reacted with ammonia. For example, as explained above, the polyfarnesene-based monol or diol may be provided by anionic polymerization of farnesene monomers in which the living terminal ends of the polymer are quenched using an epoxide followed by contact with a protic source. If the epoxide used is an alkylene oxide having the following structure:

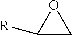

in which R is a C₁₋₂₀alkyl group, the resulting monol or diol will be a secondary alcohol. The secondary hydroxyl-groups may then be reacted directly with ammonia in the presence of hydrogen and a catalyst under pressure (e.g. >2 MPa) to provide amine-terminated polyfarnesene. A stoichiometric excess of ammonia with respect to the hydroxyl groups may be used. Examples of catalysts for the amination include, but are not limited to, copper, cobalt and/or nickel, and metal oxides. Suitable metal oxides include, but are not limited to, Cr₂O₃, Fe₂O₃ ZrO₂, Al₂O₃, and ZnO.

In yet another method, the polyfarnesene having one or two amino end groups may be obtained by adding acrylonitrile to either a primary or secondary OH end of a monol or diol through Michael addition, followed by reduction to form one or two primary amino group at the terminal ends. The polyfarnesene-based monol or diol may be dissolved in an organic solvent and mixed with a base to catalyze the reaction. Examples of bases include, but are not limited to, alkali metal hydroxides and alkoxides, such as sodium hydroxide. Acrylonitrile may then be added to the catalyst/functionalized polyfarnesene mixture dropwise. The Michael addition of acrylonitrile (cyanoethylation) to the monol or diol will form the corresponding cyanoalkylated compound.

In yet another example, the polyfarnesene may be provided with one or two epoxy end groups by, for example, a two-step process. In a first step, a polyfarnesene monol or diol and a monoepoxy compound may be combined in a solvent and allowed to react under pressure or in the presence of an inert gas, such as nitrogen or a noble gas. Examples of monoepoxy compounds include epihalohydrins, such as epichlorohydrin, beta-methylepichlorohydrin and epibromohydrin. The reactants may be optionally mixed with a catalyst, such as a metal salt or semimetal salt, the metal being selected from boron, aluminum, zinc and tin, and at least one anion selected from F−, Cl−, BF₄⁻, PF₆⁻, AsF₆⁻, SbF₆⁻, ClO₄⁻, IO₄⁻, and NO₃⁻. Following the first step, excess monoepoxy compound may be removed by distillation, for example, and then at least one alkali metal hydroxide may be added to the reaction mixture in order to form an alkali metal halide and the epoxy-terminated polyfarnesene.

According to yet another example, the polyfarnesene may be provided with one or two isocyanato end group. This may be accomplished by, for example, reacting a polyfarnesene having one or two amino end groups with phosgene.

As understood by one of skill in the art, the reactants used to provide the functionalized polyfarnesene may be dissolved in a suitable organic solvent and heat and/or pressure may be applied to the reaction to promote formation of the polyfarnesene. The reaction may be carried out batchwise or as a semicontinuous or continuous process. The reaction products may be recovered and treated by any conventional method, such as distillation, evaporation or fractionation to effect separation from unreacted material, solvent, if any, and by products.

According to the invention, said block copolymer is the reaction product of:
the at least one functionalized polyfarnesene described herein; and
at least one lactide.

In an embodiment, the poly-L-lactide-polyfarnesene block copolymer or poly-D-lactide-polyfarnesene block copolymer is produced by combining an L-lactide or a D-lactide, respectively, with a functionalized polyfarnesene, preferably a hydroxy functionalized polyfarnesene. In one or more embodiments, the block copolymer is produced by melt blending an L-lactide or a D-lactide and a functionalized polyfarnesene. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

As used herein the term “L-lactide” or “L-L-lactide” refers to (S,S)-lactide and is the cyclic di-ester of two lactic acid S enantiomers.

As used herein the term “D-lactide” or “D-D-lactide” refers to (R,R)-lactide and is a cyclic di-ester of two lactic acid R enantiomers.

In some embodiments, it is desirable to use lactide stereochemistry DD or LL having an optical purity also called isomeric purity L- or D of at least 90% by weight, preferably at least 95%, at least 98%, at least 99%, at least 99.7% by weight. An isomeric purity of at least 99.8% by weight is preferred.

Preferably, the L-lactide comprises less than 0.5% of D-lactide, preferably less than 0.2%. Preferably, the D-lactide comprises less than 0.5% of L-lactide, preferably less than 0.2%.

The present invention therefore also encompasses the process for manufacturing the block copolymer comprising the steps of:
contacting at least one functionalized polyfarnesene comprising a polymeric chain derived from farnesene and having at least one functional terminal end selected from the group comprising hydroxyl, amino, epoxy, isocyanato and carboxylic acid;
with at least one lactide; and polymerizing said lactide in the presence of said at least one functionalized polyfarnesene;
thereby forming said block copolymer comprising at least one polyfarnesene block and at least one polylactide block.

In an embodiment, the polymerization of the lactide in the presence of the at least one functionalized polyfarnesene occurs via ring opening polymerization.

In an embodiment, the polymerization of the lactide in the presence of the at least one functionalized polyfarnesene occurs in the presence of a catalyst.

In an embodiment, the polymerization of the lactide in the presence of the at least one functionalized polyfarnesene occurs in the presence of a catalyst having general formula M(Y₁, Y², . . . Y^{p})_{q}, wherein M is a metal selected from the group comprising the elements of columns 3 to 12 of the periodic table of the elements, as well as the elements Al, Ga, In, TI, Ge, Sn, Pb, Sb, Ca, Mg and Bi; whereas Y¹, Y², . . . Y^{p} are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carboxylate and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl)phenoxy)(ethoxy)zinc, or Zn(lactate)₂.

In an embodiment, the block copolymer can be produced by combining a lactide, respectively, with a functionalized polyfarnesene, preferably a hydroxy functionalized polyfarnesene. In some embodiments, the block copolymer can be produced by ring-opening polymerization of lactide using a hydroxy functionalized polyfarnesene as an initiator. Such processes may utilize catalysts, as described herein above, for polylactide formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

The polymerization can be performed at a temperature of 150° C.-200° C. in bulk, or 90° C.-110° C. in solution. The temperature is preferably that of the reaction itself. According to an embodiment, without solvent, the polymerization can be performed at a temperature of 150° C.-200° C. in bulk.

The invention relates to a composition comprising at least two polymers, wherein, the first polymer is a block copolymer comprising at least one polyfarnesene block and at least one poly-L-lactide block; and, the second polymer is selected from poly-D-lactide, or a block copolymer comprising at least one polyfarnesene block and at least one poly-D-lactide block;

or, the first polymer is a block copolymer comprising at least one polyfarnesene block and at least one poly-D-lactide block; and, the second polymer is selected from poly-L-lactide, or a block copolymer comprising at least one polyfarnesene block and at least one poly-L-lactide block, wherein said block copolymer is the reaction product of:

at least one functionalized polyfarnesene comprising a polymeric chain derived from farnesene and having at least one functional terminal end selected from the group comprising hydroxyl, amino, epoxy, isocyanato, and carboxylic acid; and at least one lactide.

As used herein, the terms “polylactide” or “polylactic acid” or “PLA” are used interchangeably and refer to poly(lactide) polymers comprising repeat units derived from lactide.

Polylactide can be prepared according to any method known in the state of the art. The polylactide can be prepared by ring-opening polymerization of raw materials having required structures selected from lactide, which is a cyclic dimer of lactide, glycolide, which is a cyclic dimer of glycolic acid, and caprolactone and the like. Lactide includes L-lactide, which is a cyclic dimer of L-lactide, D-lactide, which is a cyclic dimer of D-lactide, meso-lactide, which is a cyclic dimer of D-lactide and L-lactide, and DL-lactide, which is a racemate of D-lactide and L-lactide. Random copolymers made from meso-lactide result in an atactic primary structure referred to as poly(meso-lactide) and are amorphous. Random optical copolymers made from equimolar amounts of D-lactide and L-lactide are referred to as poly-DL-lactide (PDLLA) or poly(rac-lactide) and are also amorphous.

The PLLA (poly-L-lactide) suitable for the invention comprises the product of a polymerization reaction of mainly L-lactides (or L,L-lactides). Other suitable PLLA can be copolymers of PLLA with some D-lactide units. The term “poly-L-lactide (PLLA)” refers to the isotactic polymer with the general structure (II):

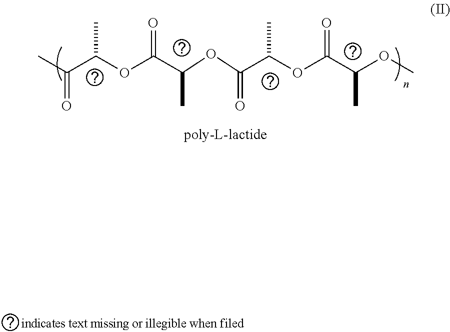

The PDLA (poly-D-lactide) for use in the present invention comprises the product of a polymerization reaction of mainly D-lactides. Other suitable PDLA can be copolymers of PDLA with some L-lactide units. The term “poly-D-lactide (PDLA)” refers to the enantiomer of PLLA.

The polylactide for use in the present composition also includes copolymers of lactide. For instance, copolymers of lactide and trimethylene carbonate according to EP 11167138 and copolymers of lactide and urethanes according to WO 2008/037772 and PCT application number PCT/EP2011/057988, hereby incorporated by reference. Copolymeric components other than lactide may be used and include dicarboxylic acid, polyhydric alcohol, hydroxycarboxylic acid, lactone, or the like, which have two or more functional groups each capable of forming an ester bonding. These are, for example, polyester, polyether, polycarbonate, or the like which have the two or more unreacted functional groups in a molecule. The hydroxycarboxylic acids may be selected from the list comprising glycolic acid, hydroxybutyric acid, hydroxyvaleric acid, hydroxypentanoic acid, hydroxycaproic acid, and hydroxyheptanoic acid. In an embodiment no comonomer is used.

In an embodiment, the PLLA and/or the PDLA which can be used in the composition respectively, can have an optical purity (called isomeric purity) of the L or D isomer, which is higher than 90% of the PLA, preferably higher than 92% of the PLA, preferably higher than 95 w % by weight. An optical purity from at least 98% by weight is more preferred, yet more preferably from at least 99%.

Optical purity can be measured by different techniques, such as NMR, polarimetry or by enzymatic method or GCMS. Preferably, optical purity is measured by enzymatic method and/or NMR, as described for herein below. Enzymatic method: The stereochemical purity of the PLLA or of the PDLA can be determined from the respective content of L-mer or of D-mer. The terms “content of D-mer” and “content of L-mer” refer respectively to the monomer units of type D and of type L that occur in polylactide, using the enzymatic method. The principle of the method is as follows: The L-lactate and D-lactate ions are oxidized to pyruvate respectively by the enzymes L-lactate dehydrogenase and D-lactate dehydrogenase using nicotinamide-adenine dinucleotide (NAD) as coenzyme. To force the reaction in the direction of formation of pyruvate, it is necessary to trap this compound by reaction with hydrazine. The increase in optical density at 340 nm is proportional to the amount of L-lactate or of D-lactate present in the sample. The samples of PLA can be prepared by mixing 25 ml of sodium hydroxide (1 mol/L) with 0.6 g of PLA. The solution was boiled for 8 h and then cooled. The solution was then adjusted to neutral pH by adding hydrochloric acid (1 mol/L), then deionized water was added in a sufficient amount to give 200 ml. The samples were then analyzed on a Vital Scientific Selectra Junior analyzer using, for L-mer determination of poly-L-lactide acid, the box titled “L-lactide 5260” marketed by the company Scil and for D-mer determination of poly-D-lactide acid, the box titled “L-lactide 5240” marketed by the company Scil. During the analysis, a reactive blank and calibration using the calibrant “Scil 5460” are used. The presence of insertion and racemization defects can also be determined by carbon-β nuclear magnetic resonance (NMR) (Avance, 500 MHz, 10 mm SELX probe). The samples can be prepared from 250 mg of PLA dissolved in 2.5 to 3 ml of CDCl₃.

In an embodiment, PLLA suitable for the composition comprises a content of D isomer of at most 20% by weight, preferably of at most 10% by weight, preferably of at most 8% by weight, preferably of at most 5% by weight, more preferably of at most 2% by weight, most preferably of at most 1% by weight of the PLLA.

In an embodiment, PDLA suitable for the composition comprises a content of L isomer of at most 20% by weight, preferably of at most 10% by weight, preferably of at most 8% by weight, preferably of at most 5% by weight, preferably of at most 2% by weight of the PDLA more preferably of at most 1% by weight of the PDLA.

In an embodiment, a process for preparing PLLA and/or PDLA suitable for the invention comprises the step of contacting at least one L-lactide or D-lactide, respectively, with a suitable catalyst, and optionally in the presence of a co-initiator. The process may be performed with or without solvent.

The catalyst employed by the process may have general formula M(Y¹, Y², . . . Y^{p})_{q}, in which M is a metal selected from the group comprising the elements of columns 3 to 12 of the periodic table of the elements, as well as the elements Al, Ga, In, TI, Ge, Sn, Pb, Sb, Ca, Mg and Bi;

whereas Y¹, Y², . . . Y′ are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carboxylate and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl) phenoxy)(ethoxy)zinc, or Zn(lactate)₂.

In an embodiment, the PLLA and/or PDLA suitable for the invention can be obtained by polymerizing L-lactide, or D-lactide, respectively, preferably in the presence of a co-initiator of formula (III),

R¹—OH (III)

wherein R¹ is selected from the group consisting of C₁₋₂₀alkyl, C₆₋₃₀aryl, and C₆₋₃₀arylC₁₋₂₀alkyl optionally substituted by one or more substituents selected from the group consisting of halogen, hydroxyl, and C₁₋₆alkyl. Preferably, R¹ is selected from C₃₋₁₂alkyl, C₆₋₁₀aryl, and C₆₋₁₀ arylC₃₋₁₂ alkyl, optionally substituted by one or more substituents, each independently selected from the group consisting of halogen, hydroxyl, and C₁₋₆alkyl; preferably, R¹ is selected from C₃₋₁₂ alkyl, C₆₋₁₀ aryl, and C₆₋₁₀ arylC₃₋₁₂ alkyl, optionally substituted by one or more substituents, each independently selected from the group consisting of halogen, hydroxyl and C₁₋₄alkyl. The initiator can be an alcohol. The alcohol can be a polyol such as diol, triol or higher functionality polyhydric alcohol. The alcohol may be derived from biomass such as for instance glycerol or propanediol or any other sugar-based alcohol such as for example erythritol. The alcohol can be used alone or in combination with another alcohol.

In an embodiment, non-limiting examples of initiators include 1-octanol, isopropanol, propanediol, trimethylolpropane, 2-butanol, 3-buten-2-ol, 1,3-butanediol, 1,4-butanediol, 1,6-hexanediol, 1,7-heptanediol, benzyl alcohol, 4-bromophenol, 1,4-benzenedimethanol, and (4-trifluoromethyl)benzyl alcohol; preferably, said initiator is selected from 1-octanol, isopropanol, and 1,4-butanediol.

The polymerization can be performed at a temperature of 150° C.-200° C. in bulk, or 90° C.-110° C. in solution. The temperature is preferably that of the reaction itself. According to an embodiment, without solvent, the polymerization can be performed at a temperature of 150° C.-200° C. in bulk.

The description of poly-L-lactide-polyfarnesene (PLLA-PF) block copolymer, or poly-D-lactide-polyfarnesene (PDLA-PF) block copolymer, for the first polymer applies mutatis mutandis to the poly-L-lactide-polyfarnesene (PLLA-PF) block copolymer, or poly-D-lactide-polyfarnesene

(PDLA-PF) block copolymer, used as second polymer.

The invention further provides a process for preparing the composition. Hence, any embodiment for of the composition is also an embodiment of the process for preparing such a composition.

Any process known in the art can be applied for preparing a composition as presently described. The process preferably comprises the step of:

contacting at least one first polymer with at least one second polymer; wherein
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block,
   wherein said block copolymer is the reaction product of:
      at least one functionalized polyfarnesene comprising a polymeric chain derived from farnesene and having at least one functional terminal end selected from the group comprising hydroxyl, amino, epoxy, isocyanato, and carboxylic acid; and
      at least one lactide.

In some embodiments, said contacting step comprises melt blending the at least one first polymer with the at least one second polymer. In some embodiments, said melt blending process occurs, in a single step. The blending may occur by introducing the first polymer and the second polymer, into a system capable of combining and melting the components to initiate chemical and/or physical interactions between the first and second polymer components. For example, the blending may be accomplished by introducing the first and second polymers into a batch mixer, continuous mixer, single screw extruder or twin screw extruder, for example, to form a homogeneous mixture or solution while providing temperature conditions so as to melt the blend components and initiate chemical and physical interactions the first and second polymer components as described above.

In an embodiment, the composition is prepared by mixing. In an embodiment, the composition is mixed at a temperature of at least 140° C., for example at least 150° C., for example at least 160° C., for example ranging from 160° C. to 230° C. More preferably, the composition is mixed at a temperature ranging from 180° C. to 230° C.

In a preferred embodiment, the residence time in the mixer is at most 30 minutes, more preferably at most 20 minutes, more preferably at most 10 minutes, more preferably at most 8 minutes, more preferably at most 5 minutes. As used herein, the term “residence time” refers to the time wherein the mixture is present in the mixer, or is present in a series of extruders.

In an embodiment, any of the previously described compositions may further comprise additives to impart desired physical properties, such as printability, increased gloss, or a reduced blocking tendency. Examples of additives may include, without limitation, stabilizers, ultra-violet screening agents, oxidants, anti-oxidants, antistatic agents, ultraviolet light absorbents, fire retardants, processing oils, mold release agents, coloring agents, pigments/dyes, fillers or combinations thereof, for example. These additives may be included in amounts effective to impart desired properties.

In some embodiments, said process for preparing a composition according to the present invention further comprises processing the composition using one or more polymer processing techniques selected from film, sheet, pipe and fiber extrusion or coextrusion; blow molding; injection molding; rotomolding; foaming; 3D printing, and thermoforming.

In some embodiments, said contacting step comprises melt processing a blend comprising the at least one first polymer with the at least one second polymer to allow formation of stereocomplex crystallites in the blend during the processing.

As used herein, the term “stereocomplex” refers to an interlocking composite prepared with two complementary polymeric structures, and which possesses different physical characteristics from the individual polymers. The term “complementary” structures can refer to two polymers that are homopolymers of the individual enantiomers of an optically active molecule such that each polymer is optically active. “Complementary” can also refer to two polymers that bear similar but not identical chemical structures in which case the polymers relate to one another as diastereomers rather than enantiomers. Even further, “complementary” can even refer to unrelated but optically active polymers of opposite polarity that are capable of forming stereocomplexes in which case the stereocomplex is called a “hetero-stereocomplex”. In some embodiment, the temperature stability is maximized when a 1/1 blend PDLA/PLLA is used, but even at lower concentrations of 3-10% by weight of PDLA, there is still a substantial improvement. In the latter case, PDLA acts as a nucleating agent, thereby increasing the crystallization rate. Biodegradation of the stereo-complex is slower then optically pure PLA, due to the higher crystallinity of stereo-complex. The presence of a stereo-complex can be determined by DSC, where a typical melting peak can be found for the stereo-complex around 215-230° C.

In a preferred embodiment, the residence time in the extruder is at most 30 minutes, more preferably at most 20 minutes, more preferably at most 10 minutes, more preferably at most 8 minutes, more preferably at most 5 minutes. As used herein, the term “residence time” refers to the time wherein the mixture is present in the extruder, or is present in a series of extruders.

In an embodiment, any of the previously described compositions may further comprise additives to impart desired physical properties, such as printability, increased gloss, or a reduced blocking tendency. Examples of additives may include, without limitation, stabilizers, ultra-violet screening agents, oxidants, anti-oxidants, antistatic agents, ultraviolet light absorbents, fire retardants, processing oils, mold release agents, coloring agents, pigments/dyes, fillers or combinations thereof, for example. These additives may be included in amounts effective to impart desired properties.

In some embodiments, said process for preparing a composition according to the present invention further comprises processing the composition using one or more polymer processing techniques selected from film, sheet, pipe and fiber extrusion or coextrusion; blow molding;

injection molding; rotomolding; foaming; 3D printing, and thermoforming.

The present invention also encompasses polymers, membranes, adhesives, foams, sealants, molded articles, films, extruded articles, fibers, elastomers, composite material, adhesives, organic LEDs, organic semiconductors, and conducting organic polymers, 3D printed articles, comprising the composition according to the present invention.

The present invention also encompasses an article comprising a composition according to any of the embodiments previously described for the present invention, or prepared using a process according to the invention.

In some embodiments, said article comprising a composition according to any of the embodiments previously described for the present invention, or prepared using a process according to the invention; is a shaped article.

In some embodiments, said shaped article comprising a composition according to any of the embodiments previously described for the present invention, or prepared using a process according to the invention; is a molded article.

In an embodiment, said shaped article is produced by polymer processing techniques known to one of skill in the art, such as blow molding, injection molding, rotomolding, compression molding, 3D printing, and thermoforming.

In an embodiment, the compositions and blends thereof may be formed into a wide variety of articles such as films, pipes, fibers (e.g., dyeable fibers), rods, containers, bags, packaging materials, 3D printed articles, and adhesives (e.g., hot melt adhesives) for example, by polymer processing techniques known to one of skill in the art, such as forming operations including film, sheet, pipe and fiber extrusion and co-extrusion as well as blow molding, injection molding, rotomolding, 3D printing, and thermoforming, for example. Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, hot melt adhesives, sheets, such as thermoformed sheets (including profiles and plastic corrugated cardboard), geomembranes and pond liners, for example. Molded articles include single and multilayered constructions in the form of bottles, tanks, large hollow articles, rigid food containers and toys, for example.

The invention also provides in the use of a block copolymer comprising at least one polyfarnesene block and at least one polylactide block, wherein said polylactide block is a poly-L-lactide block or a poly-D-lactide block, as nucleating agent for polymers. Preferably, said polymer is polylactide, preferably optical pure polylactide.

Any embodiment of the copolymer described above is also an embodiment of this use.

In some embodiments, said block copolymer is poly-L-lactide-polyfarnesene block copolymer or poly-D-lactide-polyfarnesene block copolymer.

The invention also provides in the use of a block copolymer comprising at least one polyfarnesene block and at least one polylactide block, wherein said polylactide block is a poly-L-lactide block or a poly-D-lactide block, as stereo-complex forming agent for polylactide. Any embodiment of the copolymer described above is also an embodiment of this use.

In some embodiments, said block copolymer is poly-L-lactide-polyfarnesene block copolymer or poly-D-lactide-polyfarnesene block copolymer.

The invention also provides in the use of a block copolymer comprising at least one polyfarnesene block and at least one polylactide block, wherein said polylactide block is a poly-L-lactide block or a poly-D-lactide block, as melting point increasing agent for polylactide. Any embodiment of the copolymer described above is also an embodiment of this use.

In some embodiments, said block copolymer is poly-L-lactide-polyfarnesene block copolymer or poly-D-lactide-polyfarnesene block copolymer.

The present invention is also directed towards the use of poly-L-lactide-polyfarnesene block copolymer, or poly-D-lactide-polyfarnesene block copolymer, as additives to induce the crystallization of PDLA or PLLA respectively. In addition, the invention is also directed towards the use of poly-L-lactide-polyfarnesene block copolymer, or poly-D-lactide-polyfarnesene block copolymer as impact modifier to improve melt strength and impact strength for PDLA or PLLA respectively.

The present invention also encompasses a method for inducing the crystallization of poly-L-lactide comprising contacting a poly-L-lactide or a copolymer thereof with at least one first polymer selected from poly-D-lactide-polyfarnesene block copolymer.

The present invention also encompasses a method for inducing the crystallization of poly-D-lactide comprising contacting a poly-L-lactide or a copolymer thereof with at least one first polymer selected from poly-L-lactide-polyfarnesene block copolymer.

The present invention also encompasses a method for inducing the crystallization of PLLA or PDLA respectively comprising melt processing a blend comprising PDLA and poly-L-lactide-polyfarnesene block copolymer or PLLA and poly-D-lactide-polyfarnesene block copolymer to allow formation of PLLA/PDLA stereocomplex crystallites in the blend during the processing.

The present invention also encompasses the use of poly-L-lactide-polyfarnesene block copolymer, poly-D-lactide-polyfarnesene block copolymer, as polymer additive.

The present invention also encompasses the use of poly-L-lactide-polyfarnesene block copolymer, poly-D-lactide-polyfarnesene block copolymer, as impact modifier for polymers.

The present invention can be further illustrated by the following examples, although it will be understood that these examples are included merely for purposes of illustration and are not intended to limit the scope of the invention unless otherwise specifically indicated.

### EXAMPLES

Unless otherwise indicated, all parts and all percentages in the following examples, as well as throughout the specification, are parts by weight or percentages by weight respectively.

Materials

Trans-β-farnesene was purchased from Amyris (CAS number 18794-84-8). The structure of trans-β-farnesene is given in formula (I)

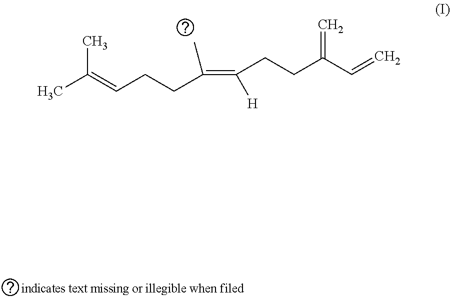

Solvents such as methanol, chloroform and toluene were purchased from Sigma-Aldrich, as anhydrous liquids.

n-Butyl lithium was purchased from Sigma Aldrich.

Propylene oxide was purchased from Sigma-Aldrich.

2-Tin-ethylhexanoate was purchased from VWR (Alfa Aesar supplier) with a purity of 96%. Lactide, Purified L-lactide from Corbion, named Puralact L was used.

Inge® ™ Biopolymer 2500HP (PLA HP2500) was purchased from NatureWorks.

The physical properties of Inge® ™ Biopolymer 2500HP are shown in Table 1.

TABLE 1a

| Physical Properties | Ingeo Resin | ASTM Method |
|---|---|---|
| Specific Gravity | 1.24 | D792 |
| MFR, g/10 min (210° C., 2.16 kg) | 8 | D1238 |
| Relative viscosity(1) | 4.0 | D5225 |

(1)RV measured at 1.0 g/dL in chloroform at 30° C.

PDLA D070 was purchased from Corbion having a Mn of 41 kg/mol, a Mw of 65 kg/mol, and a D/L ratio of 99.8/0.2. The physical properties of PDLA D070 are shown in Table 1 b.

TABLE 1b

| | PDLA D070 | |
|---|---|---|
| Physical Properties | Resin | ASTM Method |
| density (g/cm³) | 1.24 | D792 |
| MFR, g/10 min (210° C., 2.16 kg) | >75 | D1238 |

PLLA 1010 was purchased from Synbra Technology by, with the following characteristics: a melt flow rate of 22 (+−5) g/600 s (ISO 1133 (190° C./2.16 kg), a density of 1.25 g/cm³ (ISO 1183), a D-isomer content lower than 1%, a melting temperature of 175-180° C. (DSC:ISO 11357) and a glass transition temperature of 55-60° C. (DSC:ISO 11357).

Methods

The molecular weight (Mₙ (number average molecular weight), M_{w} (weight average molecular weight), Mₚ (peak molecular weight) and molecular weight distributions d (M_{w}/Mₙ), and d′ (M_{z}/M_{w}) were determined by size exclusion chromatography (SEC) and in particular by gel permeation chromatography (GPC). Briefly, a GPC-IR5 from Polymer Char was used: 10 mg polymer sample was dissolved at 160° C. in 10 ml of trichlorobenzene for 1 hour. Injection volume: about 400 μl, automatic sample preparation and injection temperature: 160° C. Column temperature: 145° C. Detector temperature: 160° C. Two Shodex AT-806MS (Showa Denko) and one Styragel HT6E (Waters) columns were used with a flow rate of 1 ml/min. Detector: Infrared detector (2800-3000 cm-1). Calibration: narrow standards of polystyrene (PS) (commercially available). Calculation of molecular weight Mᵢ of each fraction i of eluted polyethylene is based on the Mark-Houwink relation (log₁₀(M_{PE})=0.965909×log 10(MPS)−0.28264) (cut off on the low molecular weight end at M_{PE}=1000).

The molecular weight averages used in establishing molecular weight/property relationships are the number average (Mₑ), weight average (M_{w}) and z average (Mᵢ) molecular weight. These averages are defined by the following expressions and are determined form the calculated Mᵢ:

$${M}_{n} = \frac{{Σ}_{i} {N}_{i} {M}_{i}}{{Σ}_{i} {N}_{i}} = \frac{{Σ}_{i} {W}_{i}}{{Σ}_{i} {W}_{i} \text{/} {M}_{i}} = \frac{{Σ}_{i} {h}_{i}}{{Σ}_{i} {h}_{i} \text{/} {M}_{i}}$$

$${M}_{w} = \frac{{Σ}_{i} {N}_{i} {M}_{i}^{2}}{{Σ}_{i} {N}_{i} {M}_{i}} = \frac{{Σ}_{i} {W}_{i} {M}_{i}}{{Σ}_{i} {W}_{i}} = \frac{{Σ}_{i} {h}_{i} {M}_{i}}{{Σ}_{i} {h}_{i}}$$

$${M}_{z} = \frac{{Σ}_{i} {N}_{i} {M}_{i}^{3}}{{Σ}_{i} {N}_{i} {M}_{i}^{2}} = \frac{{Σ}_{i} {W}_{i} {M}_{i}^{2}}{{Σ}_{i} {W}_{i} {M}_{i}} = \frac{{Σ}_{i} {h}_{i} {M}_{i}^{2}}{{Σ}_{i} {h}_{i} {M}_{i}}$$

Here Nᵢ and Wᵢ are the number and weight, respectively, of molecules having molecular weight Mᵢ. The third representation in each case (farthest right) defines how one obtains these averages from SEC chromatograms. hi is the height (from baseline) of the SEC curve at the iₜₕ elution fraction and Mᵢ is the molecular weight of species eluting at this increment.

Thermal properties were analyzed with Perkin-Elmer Pyris Diamond differential scanning calorimeter (DSC) calibrated with indium as standard. The specimens were heated from 25 to 260° C. at a rate of 20° C./min, under N₂, followed by an isothermal at 260° C. for 3 min, a subsequent cooling scan to 25° C. at a rate of 20° C./min, and a second heating scan from 25° C. to 260° C. at a rate of 20° C./min, under N₂.

Mechanical properties of the compositions and block copolymers were investigated by Izod impact tester. Un-notched Izod impact was measured at 23° C. according to ISO180/A:2000. Un-notched test specimen 9.99 mm×4.21 mm (section 42.1 mm²) is held as a vertical cantilevered beam and is impacted at 3.5 m/s by a swinging pendulum (5.5 J).

Tensile modulus, tensile strength at yield, elongation at yield, tensile strength at break, elongation at break were determined according to ISO527-2012-1BA.

Preparation of polyfarnesene mono-ol

100 g of trans-β-farnesene and 200 g of methyl-tert-butyl ether (MTBE) were combined in a pressure reactor and purged three times with nitrogen. Subsequently 1.3 g of n-butyl lithium was added to the reactor at room temperature. The reaction was monitored and the temperature controlled to stay below 40° C. After polymerization was completed (approximately 15 minutes), a stoichiometric excess of propylene oxide (2.0 g) was added to the living polymerization solution, followed by adding methanol (1.3 g) for neutralization. The polymer solution was then transferred to a three-neck flask equipped with a stirrer, and mixed well for 10 minutes with purified water to wash the polymer solution. The stirring was stopped and overtime the organic phase separated from the aqueous phase, at which point the aqueous phase was discharged and the pH determined. The washing step was repeated until the aqueous phase became neutral (pH 7). The separated organic phase was transferred to another three-neck flask and the MTBE solvent was removed under nitrogen purge with heating (150° C.). When the majority of solvent was removed, the polymer was steam stripped until one-half of the steam based on polymer volume was eliminated, then the polymer was nitrogen purged at 150° C. to pull out residual water. The isolated polyfarnesene having a hydroxyl end group was cooled to 70° C. and transferred to a container. The number average molecular weight of the polyfarnesene mono-ol obtained was approximately 5000 g/mol.

Polyfarnesene mono-ol having Mn of about 20000 and 50000 Da were obtained similarly.

Preparation of Polyfarnesene Diol:

A polyfarnesene diol was prepared by combining 26.8 g (11.0 g for 50000 g/mol diol; 4.5 g for 110000 g/mol diol) of a di-lithium based initiator (prepared as described in example 2 of DD-231361 A1) and 1600 g of methyl-tert-butyl ether (MTBE) in a pressure reactor and purged with nitrogen three times. Subsequently, 225 g of trans-8-farnesene was added to the reactor at room temperature; the reaction was monitored and the temperature controlled to stay below 40° C. After polymerization was completed (approximately 15 minutes), a stoichiometric excess of propylene oxide (2.0 g) was added to the living polymerization solution, followed by adding purified water for neutralization. The polymer solution was mixed well for 15 minutes with purified water to wash the polymer solution. The stirring was stopped and over time the organic phase separated from the aqueous phase, at which point the aqueous phase was discharged and the pH determined. The washing step was repeated until the aqueous phase became neutral (pH=7). The separated organic phase was transferred to three-neck flask and the MTBE solvent was removed under nitrogen purge with heating (150° C.). When the majority of solvent was removed, the polymer was steam stripped until one-half of the steam based on polymer volume was eliminated, then the polymer was nitrogen purged at 150° C. to pull out residual water. The isolated polyfarnesene having a hydroxyl end group was cooled to 70° C. and transferred to a container. The number average molecular weight of the polyfarnesene diol was approximately 20000 (50000; 110000) g/mol.

Preparation of poly-L-lactide-polyfarnesene (PLA-PF) diblock copolymer

PLA-PF diblock copolymers were prepared by reacting polyfarnesene mono-ols as prepared above with lactide in bulk, in the presence of a catalyst.

In this specific example the polyfarnesene mono-ol with a molecular weight of 20 000 g/mol was used. 2.81 mg tin(II) 2-ethylhexanoate (Sn(Oct)₂) (6.94 μmol, 1 equivalent) was added to 1.11 g polyfarnesene mono-ol (55.56 μmol, 8 equivalents) with a molecular weight of 20 000 g/mol, placed in 1 ml of dry toluene in a glass flask, under nitrogen atmosphere in a glove box. The obtained mixture was stirred for 1 hour at 50° C. in order to homogenize the mixture and to activate the catalyst. Subsequently 10 g of pure L-lactide (0.0694 mol, 10000 equivalents) was added to the flask. The reaction mixture was stirred for 90 minutes at 185° C., to achieve a conversion higher than 90%. The crude copolymer was dissolved in CHCl₃ and purified by precipitation in ethanol. The precipitate is filtered off and dried in a vacuum oven for 1 hour at 110° C. The resulting PLA-PF diblock copolymer is further referred to as 69/20. The number average molecular weight of the PLA-block in said copolymer is 69 000 g/mol and the number average molecular weight of the polyfarnesene-block is 20 000 g/mol.

Similarly, but with 2.22 g, 3.33 g of polyfarnesene mono-ol, respectively diblock copolymers 26/20, and 21/20 were prepared.

Diblock copolymers with a polyfarnesene block of 50 000 were prepared in a similar way. Preparation of poly-L-lactide-polyfarnesene-poly-L-lactide (PLA-PF-PLA) triblock copolymer PLA-PF-PLA triblock copolymers were prepared by reacting polyfarnesene diol as prepared above with lactide in bulk, in the presence of a catalyst.

In this specific example the polyfarnesene diol with a molecular weight of 20 000 g/mol was used. 5.6 mg tin(II) 2-ethylhexanoate (Sn(Oct)₂) (13.89 μmol, 1 equivalent) was added to 2.5 g polyfarnesene diol (0.125 mmol, 9 equivalents) with a molecular weight of 20 000 g/mol, placed in 1 ml of dry toluene in a glass flask, under nitrogen atmosphere in a glove box. The obtained mixture was stirred for 1 hour at 50° C. in order to homogenize the mixture and to activate the catalyst. Subsequently 10 g of pure L-lactide (0.0694 mol, 5000 equivalents) was added to the flask. The reaction mixture was stirred for 90 minutes at 185° C., to achieve a conversion higher than 90%. The crude copolymer was dissolved in CHCl₃ and purified by precipitation in ethanol. The precipitate is filtered off and dried in a vacuum oven for 1 hour at 110° C. The resulting PLA-PF-PLA triblock copolymer is further referred to as 34/20/34. The number average molecular weight of each PLA-block in said copolymer is 34 000 g/mol and the number average molecular weight of the polyfarnesene-block is 20 000 g/mol.

Triblock copolymer 37/50/37 was similarly prepared with 15.1 g of lactide and 10.2 g of polyfarnesene diol. Triblock copolymer 24/50/24 was similarly prepared with 10.1 g of lactide and 10.1 g of polyfarnesene diol.

Similarly, the following di- and triblock copolymers have been made:
PLLA-PF-PLLA 24/50/24, a triblock copolymer comprising two PLLA blocks with a number average molecular weight of 24 000 g/mol each and one PF block in-between the two PLLA block with a molecular weight of 50 000 g/mol.
PLLA-PF-PLLA 37/50/37, a triblock copolymer comprising two PLLA blocks with a number average molecular weight of 37 000 g/mol each and one PF block in-between the two PLLA block with a molecular weight of 50 000 g/mol.
PLLA-PF 26/20, a biblock copolymer comprising one PLLA block with a number average molecular weight of 26 000 g/mol and one PF block with a molecular weight of 20 000 g/mol.
PLLA-PF 21/20, a biblock copolymer comprising one PLLA block with a number average molecular weight of 21 000 g/mol and one PF block with a molecular weight of 20 000 g/mol.
PLLA-PF 110/50, a biblock copolymer comprising one PLLA block with a number average molecular weight of 110 000 g/mol and one PF block with a molecular weight of 50 000 g/mol.

Table 2 shows a list of the prepared block copolymers and their characteristics. Column 1 of Table 2 names the different copolymers, the nomenclature referring to their composition. The first digit refer to the number average molecular weight in kDa of the PLA block separated by a back slash from the second digits, referring to the number average molecular weight in kDa of the PF block. The optional third digits refer the number average molecular weight in kDa of the optional second PLA block. Column 2 shows the number of polymer blocks in the copolymer. Column 3 shows the percentage by weight of solid material that is recovered after polymerization and work-up, expressed compared to the weight of the initial starting materials, being the weight of the lactide and the weight of the polyfarnesene. Column 4 shows the percentage by weight of the recovered solids after polymerization and work-up that is pure PLA, meaning PLA that is nota copolymer with polyfarnesene, and this is expressed compared to the weight of the initial starting materials, being the weight of the lactide and the weight of the polyfarnesene. Column 5 shows the percentage by weight of the recovered solids after polymerization and work-up that is copolymer, and this is expressed compared to the weight of the initial starting materials, being the weight of the lactide and the weight of the polyfarnesene. Columns 6-8 show the number average molecular weights of each of the blocks of the block copolymer. Column 9 shows the experimentally determined percentage by weight of the copolymer that is polyfarnesene, this is determined from the ratio of Mn polyfarnesene (starting material) over Mn copolymer. Column 10 shows the number average molecular weight of the copolymer. Column 11 shows the weight average molecular weight of the copolymer. Column 12 shows the peak molecular weight of the copolymer and column 13 shows the molecular weight distribution D (Mw/Mn) of the copolymer, determined as described above.

TABLE 2

| | | | | | Bloc 1 | Bloc | Bloc | % PF | GPC | GPC | GPC | |
|---|---|---|---|---|---|---|---|---|---|---|---|---|
| | | | % | | PLA | 2 PF | 3 PLA | exp. | Mn | Mw | Mp | |
| | Number | % | PLA | % | (Mn) | (Mn) | (Mn) | (Mn ratio) | Copo | Copo | Copo | |
| Ref. | of blocks | Precipitation | pure | copolymer | Da | Da | Da | % w/w | Da | Da | Da | GPC D |
| L-F | | | | | PLA-- | --PF | | | | | | |
| 26/20 | 2 | 93 | 46 | 47 | 26 000 | 20 000 | 0 | 43 | 46 000 | 89 000 | 51 000 | 1.9 |
| 21/20 | 2 | 93 | 32 | 61 | 21 000 | 20 000 | 0 | 49 | 41 000 | 77 000 | 34 000 | 1.9 |
| 110/50 | 2 | 92 | 59 | 33 | 110 000 | 50 000 | 0 | 30 | 160 000 | 325 000 | 340 000 | 2.0 |
| L-F-L | | | | | PLA-- | --PF-- | --PLA | | | | | |
| 37/50/37 | 3 | 96 | — | — | 37 000 | 50 000 | 37 000 | 40 | 124 000 | 224 000 | 230 000 | 1.8 |
| 24/50/24 | 3 | 94 | — | — | 24 000 | 50 000 | 24 000 | 51 | 98 000 | 157 000 | 131 000 | 1.6 |

Properties of the Block Copolymers

Samples were injection molded using the block copolymers (Table 3) for further testing. The block copolymer was heated from 140° C. to 210° C., the heating time was 3 minutes, the injection time was 2 seconds and this without support pressure.

Table 3 shows an overview of the properties of the PLA-PF block copolymers according to the invention, no purification has been carried out to separate the pure PLA side product from the PLA-PF copolymer.

Column 1 of Table 3 names the different copolymers, entry 1 (PLA) shows the results for the reference material of pure PLA polymer, said reference PLA material is commercial available from NatureWorks under the name Ingeo™ Biopolymer 2500HP. Column 2 shows the glass transition temperature of the PLA component of the copolymers, determined by DSC according to ISO 11357 with a gradient going from 20 to 260° C. at 20° C./min. Column 3 shows the melting temperature of the copolymers, determined by DSC according to ISO 11357 with a gradient going from 20 to 260° C. at 20° C./min. Column 4 shows the crystallization temperature of the copolymers, determined according to ISO 11357 with a gradient going from 20 to 260° C. at 20° C./min. Column 5 shows the tensile modulus of the copolymers. Column 6 shows the tensile strength at yield of the copolymers. Column 7 shows the elongation at yield of the copolymers. Column 8 shows the tensile strength at break of the copolymers. Column 9 shows the elongation at break of the copolymers.

TABLE 3

| | | | | | Tensile | | Tensile | |
|---|---|---|---|---|---|---|---|---|
| | | | | Tensile | strength | Elongation | strength | Elongation |
| | Tg(PLA) | Tm | Tc | modulus | at yield | at yield | at break | at break |
| Ref. | ° C. | ° C. | ° C. | Mpa | Mpa | % | Mpa | % |
| PLA | ~65 | ~176 | ~115 | 2732 | dumbbell | dumbbell | 66 | 4 |
| | | | | | broken | broken | | |
| | | | | | before yield | before yield | | |
| L-F | | | | | | | | |
| 26/20 | 61 | 173 | 123 | 26 | 0.7 | 1.5 | 0.6 | 2.7 |
| 21/20 | 58 | 175 | 114 | | | | | |
| 110/50 | 62 | 175 | 114 | 2189 | 44 | 2.4 | 27 | 4.9 |
| L-F-L | | | | | | | | |
| 37/50/37 | 62 | 174 | — | 52 | 1.7 | 2.4 | 1.5 | 3 |
| 24/50/24 | 63 | 174 | — | 23 | 0.8 | 4 | 0.9 | 6 |

Nucleating Effect of the Block Copolymers

The following blends were prepared and tested for their properties:
89% by weight PDLA+11% by weight PLLA;
89% by weight PDLA+11% by weight PLLA-PF-PLLA 24/50/24;
93% by weight PDLA+7% by weight PLLA;
93% by weight PDLA+5% by weight PLLA-PF 26/20+2% by weight PLLA-PF 21/20;
   the percentages by weight being expressed compared to the total weight of the blend.

Blends were made using an internal mixer Brabender. The blends were made at 200° C., 50 rpm for 5 minutes. The total mass of all the components used to make the blend was 55 g.

Samples were injection molded for further testing. The blends were heated from 140° C. to 220° C., the mold was at room temperature (23° C.), the heating time was 3 minutes, the injection time was 2 seconds and this without support pressure.

The amorphous samples were produced by letting the mold cool down spontaneously after injection, from 220° C. to room temperature (23° C.). The crystallized samples were produced by letting the mold spontaneously cool to 110° C. after injection and maintaining the temperature at 110° C. for 1 hour before allowing the mold to cool spontaneously to room temperature (23° C.).

Table 4 shows the properties of the blends. Table 4, row 3 shows the tensile modulus of the blends._Row 4 shows the tensile strength at yield of the blends. Row 5 shows the elongation at yield of the blends. Row 6 shows the tensile strength at break of the blends. Row 7 shows the elongation at break of the blends. Row 8 shows the Izod impact strength (un-notched) of the blend. The remaining rows show the thermal properties determined by DSC and this according to ISO 11357 with a gradient from 20 to 260° C. at 20° C./min. For both the first heating and the second heating the glass transition temperature (Tg), the melt temperature (Tm) of the blend and the melt temperature (sc-PLA Tm) of PLA stereo-complex was determined. Also the amount of heat associated with the melting of the blend and the melting of the stereo-complex was quantified.

It can be seen that for all the example the sc-PLA melting peak (around 220-225° C.) is present, hence crystallization occurred and that the PLLA-PF block copolymers are good nucleating agents. In addition, a significant improvement in impact resistance was recorded for the PLLA-PF-PLLA 24/50/24 block copolymer.

TABLE 4

| | | | | | | | | 93% PDLA + | |
|---|---|---|---|---|---|---|---|---|---|
| | | | | | | | | 5% PLLA-PF | |
| | | | | 89% PDLA + 11% | | | | 26/20 + | |
| | | 89% PDLA + | | PLLA-PF-PLA | | 93% PDLA + | | 2% PLLA-PF | |
| | | 11% PLLA | | 24/50/24 | | 7% PLLA | | 21/20 | |
| | | amorph. | crystal | amorph. | crystal | amorph. | crystal | amorph. | crystal |
| Traction | Tensile modulus | 2608 ± 8 | 2738 ± 32 | 2233 ± 21 | 2558 ± 37 | 2678 ± 100 | 2903 ± 50 | 2477 ± 32 | 2693 ± 49 |
| | (MPa) | | | | | | | | |
| | Tensile strength | — | 15.94 | — | — | — | 34.1 | 33.9 ± 9.7 | — |
| | at yield (MPa) | | | | | | | | |
| | Elongation at | — | 0.6 | — | — | — | 1.3 | 1.5 ± 0.4 | — |
| | yield (%) | | | | | | | | |
| | Tensile strength | 39.7 ± 9.3 | 11.7 ± 6.0 | 41.5 ± 1.8 | 40.0 ± 1.4 | 44.2 ± 4.0 | 28.1 ±7.8 | 38.8 ± 9.3 | 29.2 ± 6.8 |
| | at break (MPa) | | | | | | | | |
| | Elongation at | 1.6 ± 0.4 | 0.7 ± 0.2 | 2.1 ± 0.1 | 1.7 ± 0.1 | 1.8 ± 0.2 | 1.3 ± 0.3 | 1.7 ± 0.4 | 1.2 ± 0.3 |
| | break (%) | | | | | | | | |
| IZOD | Impact | 12.3 ± 0.7 | 10.7 ± 0.7 | 36.1 ± 9.9 | 21.6 ± 8.9 | 12.4 ± 1.3 | 12.2 ± 1.1 | 12.0 ± 1.0 | 13.2 ± 3.1 |
| | resistance | | | | | | | | |
| | (kJ/m2) | | | | | | | | |
| DSC: | Tg (° C.) | 60 | 62 | 60 | 65 | 63 | 66 | 60 | 65 |
| 1^{st} | Tc (° C.) | 95 | ND | 94 | ND | 95 | ND | 97 | ND |
| heating | ΔHₘ Tc (J/g) | 28 | ND | 28 | ND | 11 | ND | 29 | ND |
| | Tm (° C.) | 171 | 170 | 172 | 171 | 172 | 171 | 172 | 171 |
| | ΔHₘ Tm (J/g) | 38 | 38 | 41 | 44 | 34 | 42 | 42 | 43 |
| | sc-PLA Tm (° C.) | 225 | 225 | 223 | 222 | 226 | 224 | 223 | 223 |
| | ΔHₘ sc-PLA Tm | 23 | 21 | 6 | 7 | 10 | 14 | 11 | 11 |
| | (J/g) | | | | | | | | |
| cooling | T° c. (° C.) | 102 | 101 | 100 | 100 | 100 | 99 | 100 | 99 |
| | T° c. (J/g) | 13 | 11 | <5 | 10 | 12 | 8 | 7 | 6 |
| DSC: | Tg (° C.) | 61 | 60 | 62 | 61 | 62 | 61 | 61 | 60 |
| 2^{nd} | Tc (° C.) | 103 | 104 | 108 | 105 | 104 | 104 | 113 | 111 |
| heating | ΔHₘ Tc (J/g) | 24 | 27 | 34 | 24 | 20 | 32 | 30 | 36 |
| | Tm (° C.) | 171 | 171 | 172 | 171 | 172 | 171 | 171 | 171 |
| | ΔHₘ Tm (J/g) | 44 | 45 | 41 | 44 | 40 | 47 | 43 | 43 |
| | sc-PLA Tm (° C.) | 223 | 223 | 221 | 220 | 225 | 223 | 223 | 223 |
| | ΔHₘ sc-PLA Tm | 13 | 14 | 3 | 4 | 9 | 10 | 7 | 8 |
| | (J/g) | | | | | | | | |

Formation of PLA stereo-complex:

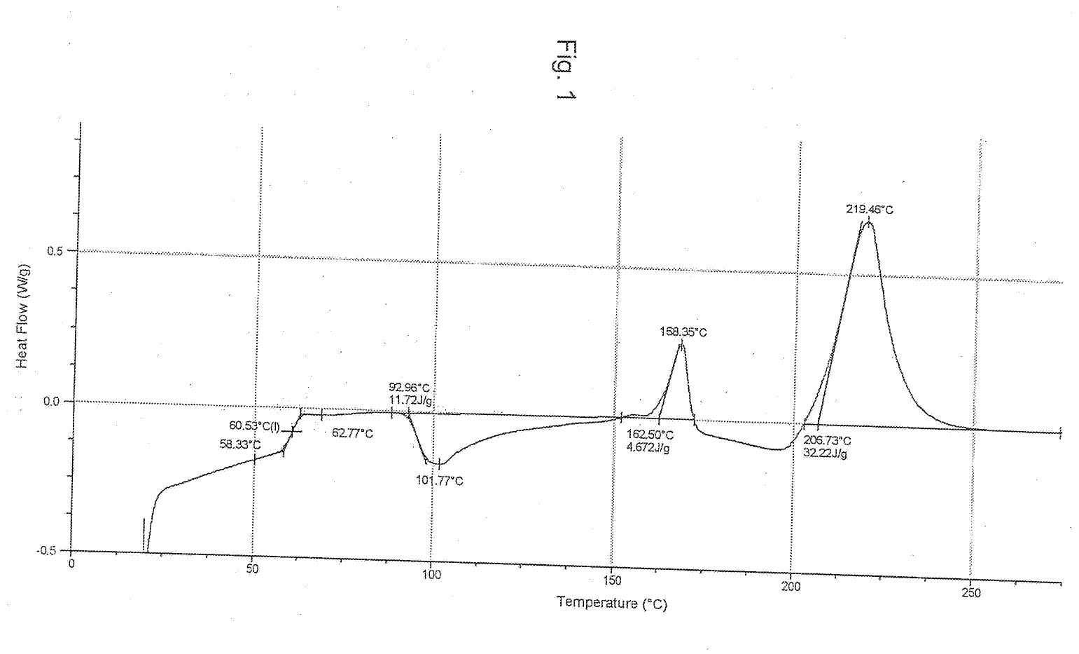

5.0 g PLLA-PF 110/50 (or 59% by weight) and 3.5 g PDLA (or 41% by weight) were mixed in CHCI₃. This mixture comprised 41% by weight of PLLA, 41% by weight of PDLA and 18% by weight of polyfarnesene. The polymer was precipitated in ethanol and dried in vacuum oven for 1 hour at 110° C. The obtained PLA mixture was injection molded as described above. The properties of PLA stereo-complexes comprising PDLA and PLLA-PF block copolymer are shown in Table 5, and a plot of the second heating run during DSC is shown in FIG. 1.

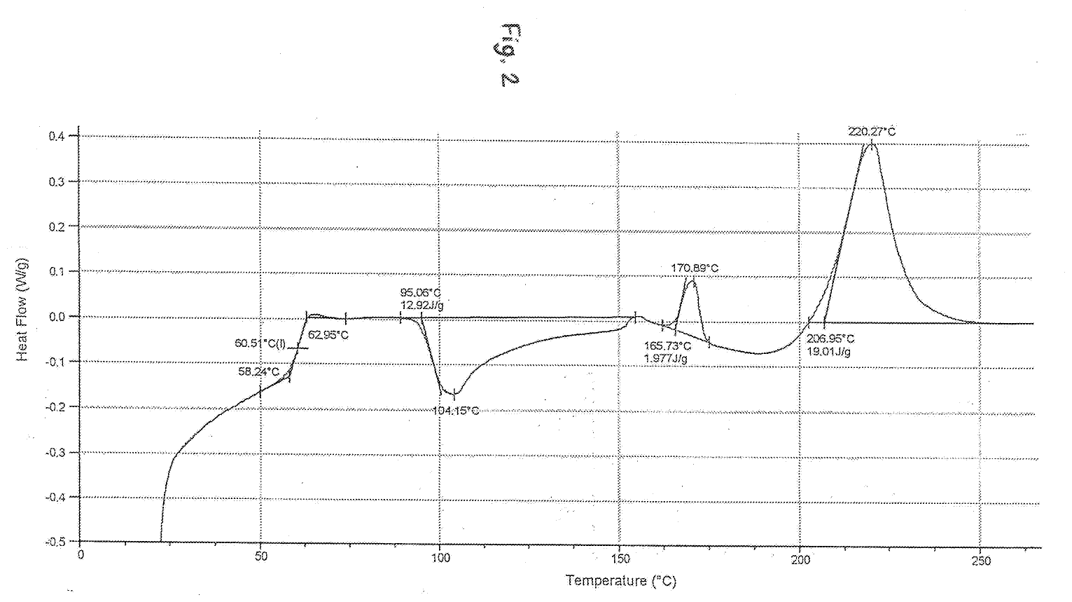

Similarly a PLA mixture was obtained by mixing 5 g of PLLA-PF-PLLA 37/50/37 (or 63% by weight) with 3 g of PDLA (or 37% by weight). The mixture comprises 37% by weight of PLLA, 37% by weight of PDLA and 26% by weight of polyfarnesene. The properties of PLA stereo-complexes comprising PDLA and PLLA-PF-PLLA block copolymer are shown in Table 5, and a plot of the second heating run during DSC is shown in FIG. 2.

TABLE 5

| | | 41% PDLA + | 37% PDLA + 63% |
|---|---|---|---|
| | | 59% PLLA-PF | PLLA-PF-PLLA |
| | | 110/50 | 37/50/37 |
| Traction | Tensile modulus (MPa) | 1401 | 432 ± 146 |
| | Tensile strength at yield | — | 4.8 |
| | (MPa) | | |
| | Elongation at yield (%) | — | 1.4 |
| | Tensile strength at break | 24.1 | 7.0 ± 3.1 |
| | (MPa) | | |
| | Elongation at break (%) | 2.1 | 1.7 ± 0.4 |
| IZOD | Impact resistance (kJ/m2) | 15.5 | 10.7 |
| DSC: | Tg (° C.) | 63 | 63 |
| 1^{st} | Tc (° C.) | 102 | 103 |
| heating | ΔHₘ Tc (J/g) | 7 | 11 |
| | Tm (° C.) | 170 | 171 |
| | ΔHₘ Tm (J/g) | 5 | 6 |
| | sc-PLA Tm (° C.) | 235 | 235 |
| | ΔHₘ sc-PLA Tm (J/g) | 50 | 25 |
| cooling | T° c. (° C.) | 125 | ND |
| | ΔHₘ T° c. (J/g) | 13 | ND |
| 2^{nd} | Tg (° C.) | 60 | 61 |
| heating | Tc (° C.) | 102 | 104 |
| | ΔHₘTc (J/g) | 12 | 13 |
| | Tm (° C.) | 168 | 171 |
| | ΔHₘ Tm (J/g) | 5 | 2 |
| | sc-PLA Tm (° C.) | 220 | 220 |
| | ΔHₘ sc-PLA Tm (J/g) | 32 | 19 |

The presence of the stereo-complex melting peeks in the DSC indicates that the stereo-complex has been formed. The size of the stereo-complex melting peeks, 50 J/g and 25 J/g, compared to the melting peeks of the amorphous fraction, around 170° C., 5 and 6 J/g of the indicate that a major part of the material is present in a stereo-complexed from. The presence of the stereo-complex in the material results in a high melting point, higher than 230° C.

1.-15. (canceled)

16. A composition comprising at least two polymers, wherein,
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block,
wherein the block copolymer is the reaction product of:
at least one functionalized polyfarnesene comprising a polymeric chain derived from farnesene and having at least one functional terminal end selected from the group comprising hydroxyl, amino, epoxy, isocyanato, and carboxylic acid; and
at least one lactide.

17. The composition according to claim 16, wherein the at least one first polymer and/or at least one second polymer is the reaction product of:
at least one polymeric chain derived from farnesene and having at least one functional terminal end selected from the group comprising hydroxyl, amino, epoxy, isocyanato, and carboxylic acid; and,
at least one lactide.

18. The composition according to claim 16, wherein the block copolymer comprising at least one polyfarnesene block and at least one poly-L-lactide block is a PLLA-PF diblock copolymer or PLLA-PF-PLLA triblock copolymer;
or,
wherein the block copolymer comprising at least one polyfarnesene block and at least one poly-D-lactide block is a PDLA-PF diblock copolymer or PDLA-PF-PDLA triblock copolymer.

19. The composition according to claim 16, wherein the composition comprises from 1% to 70% by weight of the first polymer based on the total weight of the composition.

20. The composition according to claim 16, wherein the first polymer is a block copolymer comprising at least one polyfarnesene block and at least one poly-L-lactide block, and the second polymer is a block copolymer comprising at least one polyfarnesene block and at least one poly-D-lactide block;
or,
wherein the first polymer is a block copolymer comprising at least one polyfarnesene block and at least one poly-D-lactide block, and the second polymer is a block copolymer comprising at least one polyfarnesene block and at least one poly-L-lactide block.

21. The composition according to claim 16, the first polymer is a block copolymer comprising at least one polyfarnesene block and at least one poly-L-lactide block, and the second polymer is poly-D-lactide;
or,
wherein the first polymer is a block copolymer comprising at least one polyfarnesene block and at least one poly-D-lactide block, and the second polymer is a poly-L-lactide.

22. The composition according to claim 16, wherein the number average molecular weight Mn of the block copolymer is from 2 kDa to 500 kDa.

23. The composition according to claim 16, wherein for the block copolymer, wherein the ratio of the number average molecular weight of the at least one polyfarnesene block over the number average molecular weight of the at least one polylactide block is from 1/0.1 to 1/4.0.

24. A process for preparing a composition comprising:
contacting at least one first polymer with at least one second polymer; wherein
(a) the first polymer is a block copolymer comprising at least one polyfarnesene block and at least one poly-L-lactide block; and,
(b) the second polymer is selected from poly-D-lactide, or a block copolymer comprising at least one polyfarnesene block and at least one poly-D-lactide block;
or,
(a) the first polymer is a block copolymer comprising at least one polyfarnesene block and at least one poly-D-lactide block; and,
(b) the second polymer is selected from poly-L-lactide, or a block copolymer comprising at least one polyfarnesene block and at least one poly-L-lactide block,
wherein the block copolymer is the reaction product of:
at least one functionalized polyfarnesene comprising a polymeric chain derived from farnesene and having at least one functional terminal end selected from the group comprising hydroxyl, amino, epoxy, isocyanato, and carboxylic acid; and
at least one lactide.

25. The process according to claim 24, comprising melt processing a blend a block copolymer comprising at least one polyfarnesene block and at least one poly-L-lactide block and a block copolymer comprising at least one polyfarnesene block and at least one poly-D-lactide block to allow formation of PLLA/PDLA stereocomplex crystallites in the blend during the processing.

26. An article comprising a composition according to claim 16.

27. The use of the composition of claim 16, wherein the polylactide block is a poly-L-lactide block or a poly-D-lactide block, as nucleating agent for polymers.

28. The use of the composition of claim 16, wherein the polylactide block is a poly-L-lactide block or a poly-D-lactide block, as a stereo-complex forming agent for polylactide.

29. The use of the composition of claim 16, wherein the polylactide block is a poly-L-lactide block or a poly-D-lactide block, as a melting point increasing agent for polylactide.

30. The use of the composition of claim 16, wherein the polylactide block is a poly-L-lactide block or a poly-D-lactide block, as a time regulator for biodegradability of polylactide.
